(19) United States
(12) Patent Application Publication
(10) Pub. No.: US 2011/0120328 A1
(43) Pub. Date: May 26, 2011

(54) PRINTING MODULE FOR USE IN AN OFFSET PRINTING APPARATUS AND OFFSET PRINTING APPARATUS PROVIDED WITH SUCH A PRINTING MODULE

(75) Inventors: Lambert Dirk Van Den Brink, Sudlohn (DE); Hendrikus Theodorus Gerardus Wientjes, Millingen a/d Rijn (NL)

(73) Assignee: MPS HOLDING B.V., Didam (NL)

(21) Appl. No.: 12/993,765

(22) PCT Filed: May 22, 2009
(86) PCT No.: PCT/NL09/50278

§ 371 Date: Feb. 9, 2011

(30) Foreign Application Priority Data
May 22, 2008 (NL) 2001608

(51) Int. Cl. B41F 5/18

(52) U.S. Cl. 101/176

(57) ABSTRACT

A printing module for use in an offset printing apparatus, wherein the printing module is provided with an offset plate cylinder provided with an image to be transferred onto a substrate, wherein the printing module is further provided with an ink system for applying ink onto the offset plate cylinder, at least onto the image provided thereon, and with an impression cylinder, wherein the impression cylinder is arranged, at least in use, to hold the substrate passing between the cylinders against the offset plate cylinder to transfer the image from the offset plate cylinder directly onto the substrate. The invention further relates to an offset printing apparatus provided with such a printing module.

The invention relates to a printing module for use in an offset printing apparatus, wherein the printing module is provided with an offset plate cylinder provided with an image to be transferred onto a substrate, wherein the printing module is further provided with an ink system for applying ink onto the offset plate cylinder, at least onto the image provided thereon, and with an impression cylinder.

Such a printing module is known from practice. A known printing module comprises an offset plate cylinder on which an image to be transferred is provided and a blanket cylinder situated substantially against the offset plate cylinder. The respective cylinders are driven via a driven impression cylinder provided in the module, which is situated substantially against the blanket cylinder. A substrate, for instance a web of paper, is operatively passed between the blanket cylinder and the impression cylinder. The offset plate cylinder normally comprises a steel roller having on an outer side thereof a printing plate which is provided with an image to be transferred onto the substrate. The printing module further comprises an ink system for applying ink onto the plate cylinder to provide the pattern on the plate cylinder with ink. To subsequently transfer the image onto a substrate, the image of the plate cylinder is transferred onto an outer surface of the blanket cylinder. Thereupon, the blanket cylinder transfers the image onto the substrate which is being passed between the blanket cylinder and the impression roller. The impression roller is a hard roller, for instance provided with at least a steel or ceramic outer surface, which provides back pressure to the blanket cylinder in order to transfer the image onto the substrate.

In the known printing module, the image is first transferred from the offset plate cylinder onto the blanket cylinder, after which the image is then transferred by the blanket cylinder onto the substrate. Since the image is transferred twice, the printing process with such a printing module is susceptible to loss of accuracy. This is undesired, especially in offset printing, since that requires a high degree of accuracy with a view to printing extremely fine screen gradations and high definition images.

The object of the present invention is therefore to provide an improved printing module, which printing module is arranged for accurately transferring the image of the offset plate cylinder to the substrate, whereby loss in accuracy is limited as much as possible.

To this end, the invention provides a printing module for use in an offset printing apparatus according to claim 1.

By transferring the image from the offset plate cylinder directly onto the substrate, the use of a blanket cylinder is not needed anymore. The image is transferred only a single time, so that accurate positioning of the image onto the substrate is enhanced. When, as in the prior art, a blanket cylinder is used, it is necessary to position it accurately with respect to the offset plate cylinder inter alia because the seam of the offset plate on the offset plate cylinder needs to be positioned opposite the seam of the blanket of the blanket cylinder as accurately as possible. For due to a seam there is a nonprintable area. A further advantage of the printing module according to the invention is that the chance of slip between the various cylinders is reduced, since only two cylinders are used to transfer the image. Also, operating the printing module is less laborious in that the actions regarding the blanket cylinder, for instance the frequent change of the blanket, do not need to be carried out. Finally, as a result of this configuration, the printing module is simple to construct, which is favorable to the cost price of the product.

Partly because the printing module only comprises a single plate cylinder and an impression cylinder cooperating therewith, the printing module, is arranged to enable simple changing from offset printing technology to at least one other technology, not being offset printing, while at least the plate cylinder and the impression cylinder are positioned in the printing module with respect to each other such that both a rotational direction of a respective plate cylinder and a web direction of the substrate in the respective other printing technology comprise a same direction as in the offset printing technology. A so configured printing module is particularly flexible and can be converted with relatively few operations to a printing module capable of printing a substrate using a printing technology other than offset printing technology. Since for each printing technology the impression cylinder is provided at the same location in the printing module, and the plate cylinder is positioned at a same location with respect to the impression cylinder, and these, in use, rotate in a same direction in the different printing technologies, the web direction of the substrate does not need to be altered. When changing printing technology, only a few elements of the printing module need to be adapted, for instance the kind of plate cylinder and the corresponding ink system, so that downtime of the offset printing apparatus as a result of the change of printing technology can be limited to a minimum. This is especially favorable in case of an offset printing apparatus where several times a day switching is needed between printing technology, screen size, color, printing plate, and the like, as in the case of a label printing apparatus. By providing an offset printing apparatus with several of such printing modules according to the invention, it is possible to easily change the order of printing, that is, the order of the consecutive different printing techniques in the printing apparatus. When for instance a different kind of label with a different size needs to be printed, the offset printing apparatus can be changed at will by changing the individual printing modules.

The offset plate cylinder is arranged for drivable rotation and the impression cylinder is arranged for non-driven rotation. It is then particularly favorable if, according to a further elaboration of the invention, at least an outer surface of the impression cylinder is of a flexible material, for instance of a rubber. In the known printing module whose impression roller is driven, the dimensioning of the impression cylinder, at least the circumference of the impression cylinder, is of importance in order for the substrate web speed to correspond to the circumferential speed of the blanket cylinder. Therefore the impression cylinder is made of a hard material, for instance steel. As the impression cylinder, according to an embodiment of the invention, is not driven, the dimensioning of the impression cylinder is less of importance. The impression cylinder, at any rate at least the outer surface of the cylinder, can hence be made of a different, for instance flexible, material. The advantage of a flexible outer wall or wholly flexible impression cylinder is that the impression cylinder is capable of taking up fluctuations in the substrate thickness of the substrate, which is transported between the offset plate cylinder and the impression cylinder. This further enhances the quality and the accuracy of the transfer of the ink onto the substrate. Such an impression cylinder further provides for easy changing of printing technology, since a rubber impression cylinder can be used in multiple printing technologies.

It is noted that JP 2005 047246 discloses a printing module that is adapted to transfer an image of plate cylinder directly onto a substrate, wherein the substrate in use is passed between the plate cylinder and the impression cylinder, wherein the plate cylinder and the impression cylinder are both driven by different motors. The printing module can be either adapted to be used as a photogravure printing module or as a lithographic rotary printing module by changing of the plate cylinder and the ink system of said module. Therefore, the gravure plate roll of the first technology is exchanged for a version roll for the lithographic printing technology, the ink system is changed and the impression mechanism is changed as well.

To provide a flexible printing module, according to a further elaboration of the invention, the offset plate cylinder is removably provided in the printing module in order to exchange the offset plate cylinder for another plate cylinder to enable variation in pattern length and/or printing technology. According to an alternative embodiment of the invention, the offset plate cylinder can comprise a core which is provided with an offset plate cylinder sleeve detachable from the core, thereby enabling variation in pattern length and/or printing technology. By providing either a removable offset plate cylinder or an offset plate cylinder which is built up from a core with an offset plate cylinder sleeve, the printing module can be simply adapted to both a different pattern, for instance having a different pattern length, or even to a different printing technology. Consequently, an offset printing apparatus provided with an offset printing module according to the invention can be simply adapted to other printing technologies without requiring major investments to be made or substantial changes to be made to the construction of the printing apparatus.

According to a further elaboration of the invention, the printing module is preferably provided with means for varying in a center-to-center distance between the plate cylinder and the impression cylinder. This is particularly favorable when the cylinders or the sleeves are often exchanged and hence cylinders of different diameters are used. As the center-to-center distance can be adjusted, the impression cylinder can always be positioned against the plate cylinder with a desired pressure. It is further possible to move the cylinders apart so that the cylinders, or the sleeves provided around a core, are exposed so that they are easy to take out. In an embodiment of the invention, the impression cylinder can be provided at a fixed position in the printing module, and the plate cylinder, at least the plate cylinder receptacle, can be movably provided with respect to the impression cylinder. Naturally, both cylinders may be movable relative to the frame of the printing module, or only the impression cylinder may be movably provided in the printing module. Preferably, the direction of movement of the at least one cylinder extends substantially parallel with respect to a plane in which the respective central axes of the cylinders extend.

To further simplify the easy change from one printing technology to another printing technology, it is favorable, according to a further elaboration of the invention, to provide the offset ink system in the printing module movably with respect to the plate cylinder. By displacing the offset ink system relative to the plate cylinder, space can be created between the offset ink system and the plate cylinder. This affords an operator of the printing apparatus ready access to the plate cylinder, for instance to exchange it for a plate cylinder of a different size or a plate cylinder of a different printing technology. Further, for instance in the space formed between the offset ink system and the plate cylinder, a further ink system for another printing technology may be included, which further ink system is arranged to cooperate with a respective plate cylinder of the respective other printing technology.

The offset ink system of the printing module according to the invention can be arranged for dry offset printing. However, according to a further elaboration of the invention, the ink system of the printing module according to the invention can also comprise a moisturizing system for moisturizing the offset plate cylinder, with a moisturizing cylinder of the moisturizing system being placed higher in vertical direction than an ink application cylinder of the offset ink system. So the moisturizing cylinder in use is situated above the ink application cylinder, such that in use the surface of the offset printing plate is moisturized, then moves slightly downwards in the rotational direction and is then provided with ink at the non-moisturized locations of the printing plate.

By providing such a moisturizing system in the printing module, the printing module is suitable for wet offset printing. By moisturizing the printing plate during offset printing before applying ink onto the surface of the printing plate, wear on the printing plate is minimized. Also, the printing process in wet offset printing is of relatively high quality, since soiling on the printing plate is minimized by either the presence of water or the presence of ink on the outer surface of the printing plate.

To facilitate changing from the offset printing technology to another printing technology, it is favorable when at least the ink application cylinder of the offset ink system is movable relative to an upstream cylinder in the offset ink system. Thus, only the ink application cylinder may be movable relative to the ink transfer cylinder arranged directly upstream therefrom. In another embodiment of the invention, for instance, both these cylinders may be movable relative to a further cylinder in the ink system. Also, the cylinders of the ink system may be movable relative to the moisturizing system. In a favorable embodiment of the printing module according to the invention, the ink application cylinder may be provided in the printing module so as to be rotatable about an upstream ink transfer cylinder in a direction away from the plate cylinder. By moving the ink application cylinder, a space is created between the ink application cylinder and the plate cylinder, which space may be configured for receiving, for instance, at least a part of, the flexographic ink system.

According to a further elaboration, the printing module may further be arranged for changing to flexographic printing technology by replacing the offset plate cylinder with a flexographic plate cylinder or by replacing the offset plate cylinder sleeve with a flexographic plate cylinder sleeve. This makes it possible to change to flexographic printing technology by just a limited number of actions, viz. displacing the ink application cylinder, fitting at least a part of a flexographic ink system in the created space, and exchanging the plate cylinder for a flexographic plate cylinder. After thereupon positioning the ink system and the flexographic plate cylinder with respect to the impression cylinder and the substrate passing therealong, the printing apparatus is ready for use. The offset ink system of the printing module according to an exemplary embodiment of the invention can for instance comprise a holder for receiving the flexographic ink system. Such a holder can be part of the offset ink system and be provided with a receiving provision for an anilox roller of the flexographic ink system. The ink provision for applying ink to the anilox roller may be provided in the holder, such that when the anilox roller has been fitted, it is in contact with the ink provision in the holder.

Also, according to a further elaboration of the invention, the printing module may be arranged for changing to rotary screen printing technology by replacing the offset plate cylinder with a rotary screen cylinder. Preferably, according to a further elaboration of the invention, the printing module comprises a screen bearing which is arranged to receive the rotary screen printing cylinder, with the screen cylinder, in use, being received between a core provided in a plate cylinder receptacle and the screen bearing. To make the offset printing module suitable for screen printing technology, the offset plate cylinder can be replaced with a core, or the offset plate cylinder sleeve can be taken from the core. After taking off the offset plate cylinder or the offset plate cylinder sleeve, a core is situated in the plate cylinder receptacle. The core may be arranged to engage, at least partly, the screen cylinder, at least a transmission element provided around a surface of the screen cylinder, such as a gear wheel. The screen cylinder in this way can be driven by means of the core, so that the screen cylinder rotates relative to the screen bearing. Through such a screen bearing and such a core, an adaptation of the printing module to screen printing technology can be provided for in a simple manner. Preferably, at least the plate cylinder receptacle and/or the screen bearing is movably provided in the printing module, thereby allowing simple variation in screen size by exchanging the screen cylinder for a screen cylinder of a smaller or larger diameter. The screen cylinder may further be arranged to rotate around a doctor blade which is provided in the printing module in a substantially fixed manner, that is, nonrotatably, with respect to the screen cylinder.

Also, it is possible that the printing module, according to an embodiment of the invention, is arranged to change to gravure printing technology by replacing the offset plate cylinder with an engraved plate cylinder or by replacing the offset plate cylinder sleeve with an engraved plate cylinder sleeve.

In an alternative elaboration of the invention, the ink system may be removably provided in the printing module. The ink system in this way can be taken out and replaced in a simple manner, so that upon a change of printing technology, the ink provision can be easily and rapidly tuned to the printing technology.

According to a further elaboration of the invention, the impression cylinder can comprise a core which is provided with an impression cylinder sleeve detachable from the core. The use of such an impression cylinder sleeve provides the advantage that upon a change of the printing technology the impression cylinder can also be easily adapted to this printing technology. Indeed, different printing technologies require different types of rubber. The rubber type can be easily adapted by merely arranging the impression cylinder sleeve of the respective rubber type around the core after first removing the unwanted impression cylinder sleeve from the core. Also, it is possible to exchange the whole impression cylinder, for which purpose the impression cylinder is preferably removably provided in the printing module.

The invention further relates to an offset printing apparatus provided with an above-described printing module. Such an offset printing apparatus can for instance comprise a label printing apparatus which is to be suitable for rapidly changing between printing technology, order of printing technology, changing of printing plate, changing of printing color and the like. Such a printing apparatus offers similar advantages and effects to those described in relation to the printing module.

An above-described flexible printing module and flexible offset printing facility provide a printing module and printing apparatus that are simple to operate and adapt. The printing module preferably comprises for each printing technology only a single plate cylinder, a single impression cylinder and an ink system adapted to the printing technology. Since also for the offset printing technology only two cylinders are needed, the construction of the printing module, as well as of the apparatus provided with such a printing module, can be simpler than in the case of a known printing module and printing apparatus, which results in lower tooling costs, easy operability and lower costs of purchase of the printing module, or offset printing apparatus provided with such a printing module.

The present invention will be further clarified on the basis of an exemplary embodiment, with reference to the various figures, wherein:

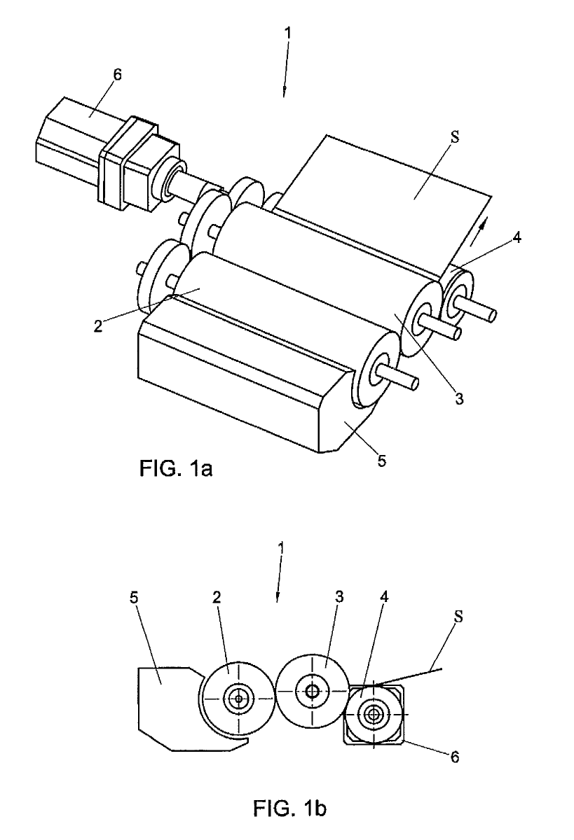

FIGS. 1a and 1b respectively show a schematic perspective view and a schematic side elevational view of an offset printing module according to the prior art;

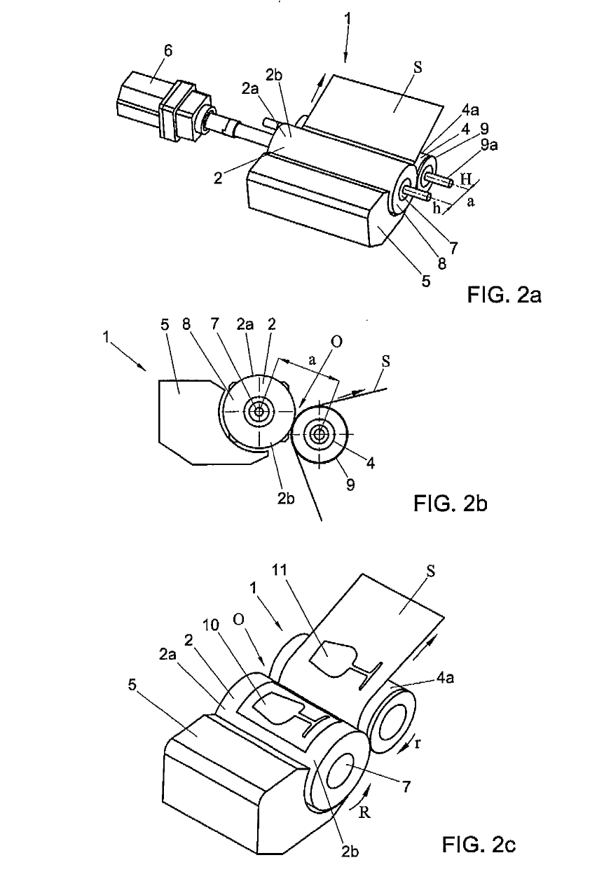

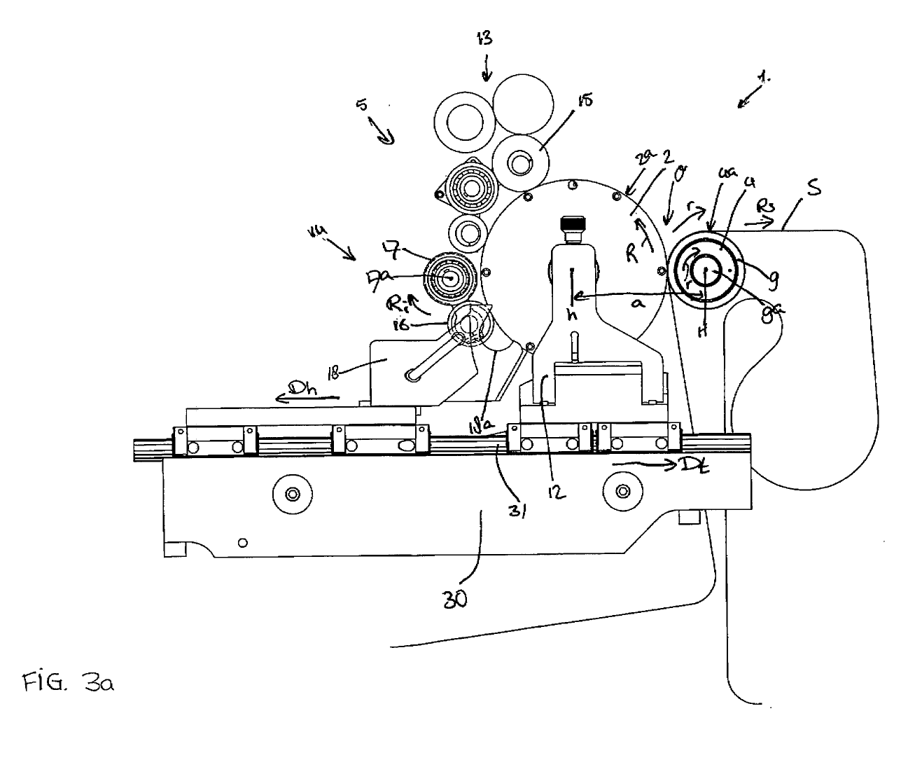

FIGS. 2a-2c show schematic perspective views and a schematic side elevational view of a printing module according to an exemplary embodiment of the invention;

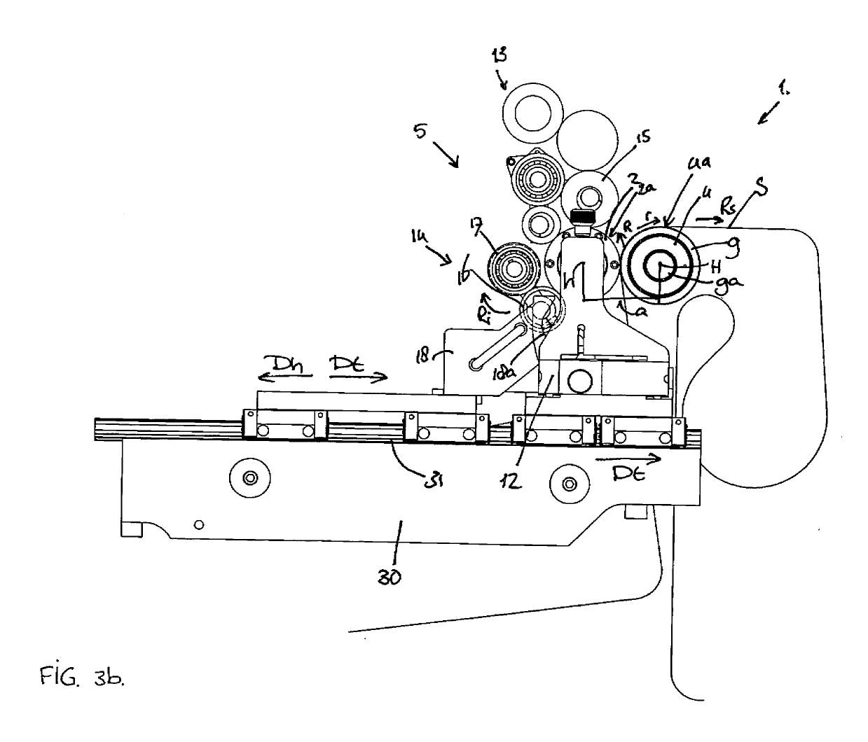

FIGS. 3a-3b show schematic side elevations of the printing module according to the invention arranged for offset printing technology;

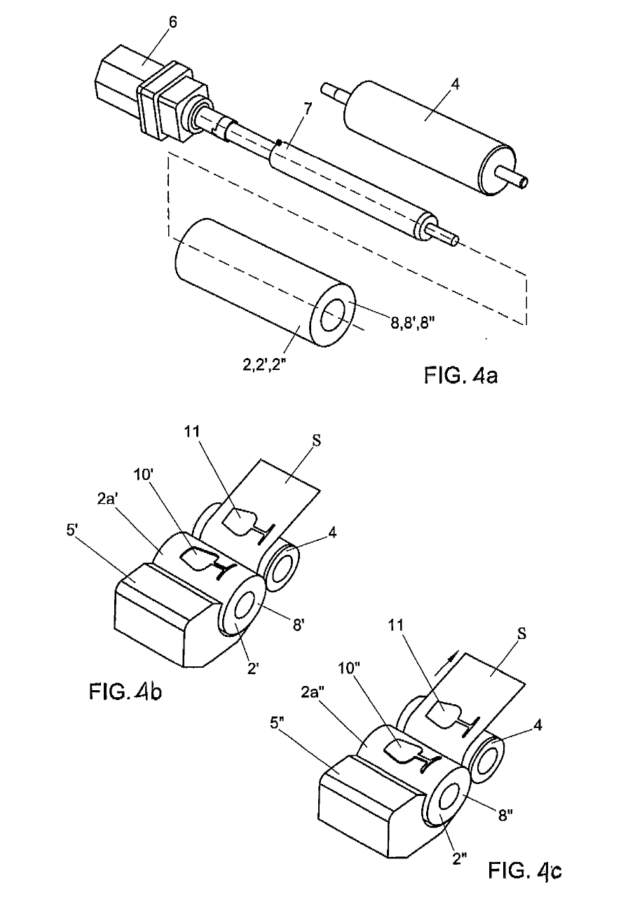

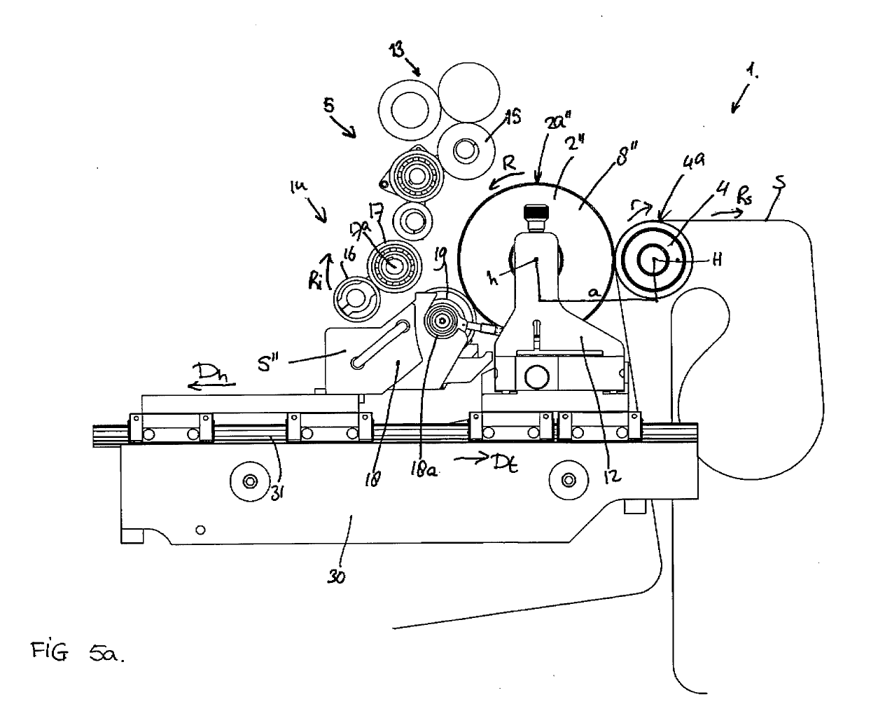

FIGS. 4a-4c show schematic perspective views of an embodiment of the printing module according to the invention arranged for other printing technologies;

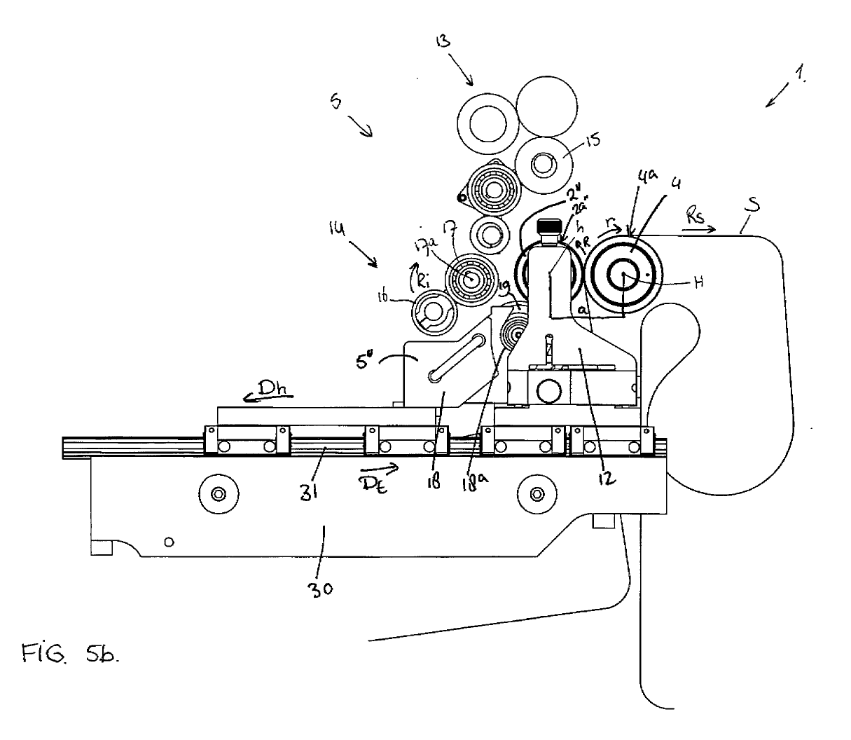

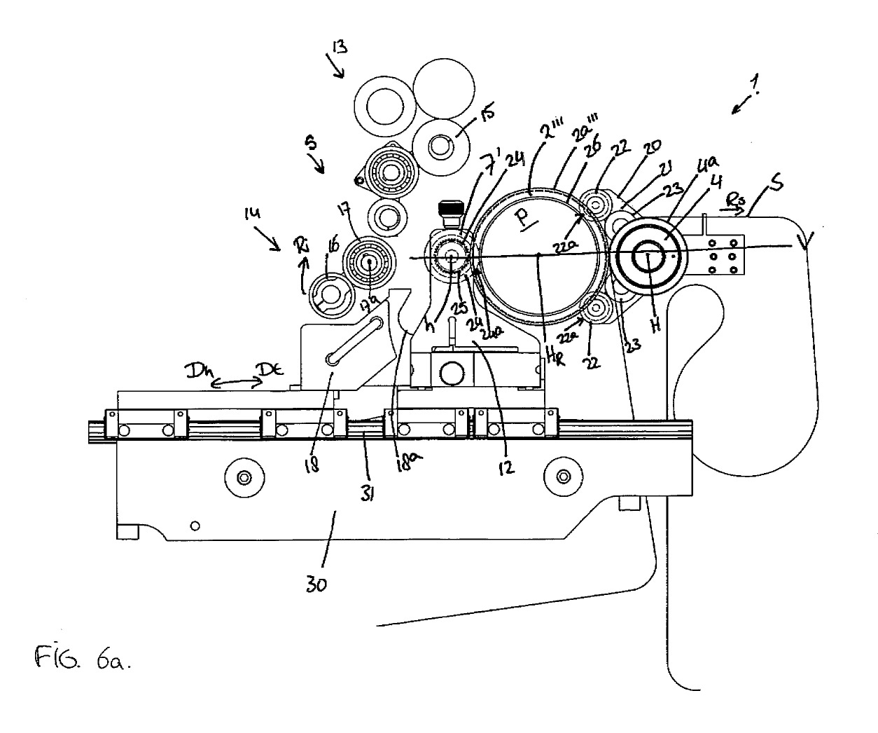

FIGS. 5a and 5b show schematic side elevations of the printing module according to the invention arranged for flexographic printing technology; and

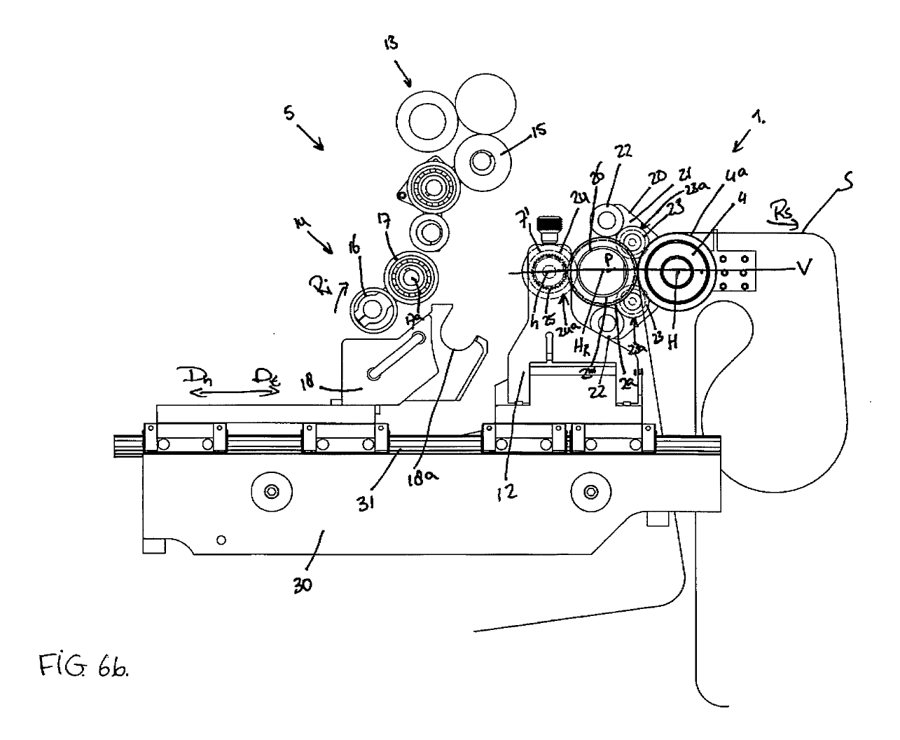

FIGS. 6a and 6b show schematic side elevations of the printing module according to the invention arranged for screen printing technology.

It is to be noted that like parts in the different figures are provided with like reference numerals.

For clarity, there is shown in FIGS. 1a and 1b a printing module 1 for an offset printing apparatus according to the prior art. The known printing module 1 comprises an offset plate cylinder 2, a blanket cylinder 3 and an impression cylinder 4. The substrate S, for instance a paper web, is passed between the blanket cylinder 3 and the impression cylinder 4, by means of the impression cylinder 4 driven by a drive 6. The impression cylinder 4 provides via, for instance, a gear transmission, for the drive of the blanket cylinder 3 and for the drive of the offset plate cylinder 2. For use in the printing module 1, the offset plate cylinder 2 is provided with an image (not shown), by fitting an offset plate provided with the image onto the offset plate cylinder 2. Next, the offset plate cylinder 2 is inserted in the printing module 1. In use, the offset plate cylinder 2, at least the image, is provided with ink using the ink system 5. The offset plate cylinder 2 transfers the ink in the form of the image onto the blanket cylinder 3, which, in turn, thereupon transfers the image onto the substrate S. The impression cylinder 4 of the known printing module 1 is made of a hard material as steel, chromium or ceramic. This is of importance for preserving accuracy of the image during the transfer of the image from the offset plate cylinder 2 to the blanket cylinder 3 and then to the substrate S.

In FIGS. 2a-2c there is represented a printing module 1 for use in an offset printing apparatus according to an embodiment of the invention. The difference with the known printing module is that in the printing module 1 according to the invention the impression cylinder 4 is arranged, at least in use, to hold the substrate S passing between the cylinders 2, 4 against the offset plate cylinder 2 to transfer the image 10 of the offset plate cylinder 2 directly onto the substrate S. For this purpose, the offset plate cylinder 2 is rotatably driven with the aid of a drive 6. The impression cylinder 4 is rotatable and is not driven. The impression cylinder 4 in use will rotate in a direction r opposite to the rotational direction R of the offset plate cylinder 2. Accordingly, there is no blanket cylinder present, so that the image of the offset plate cylinder 2 can be transferred directly onto the substrate S. In the known offset printing module, there is always a blanket cylinder required because an image cannot be accurately transferred from a plate cylinder with a hard outer surface onto a substrate when also the impression cylinder has a hard surface. The substrate S is transported through an opening 0, which opening 0 is defined by the space between the outer surfaces 2a, 4a of the cylinders 2, 4. The central axes h, H of the respective cylinders 2, 4 are substantially parallel to each other. It is to be noted that the substrate S in the different embodiments described of the printing module 1 according to the invention can comprise a continuous web of paper or plastic material, or other such suitable materials.

In FIGS. 3a and 3b there is shown a printing module 1 arranged for offset printing technology, as described above in relation to FIGS. 2a-2c. As can be seen in FIG. 3a, the printing module 1 comprises a frame 30 provided with a guide 31 which extends substantially in horizontal direction Dh, Dt. The guide 31 is arranged for movably receiving the offset ink system 5 and the plate cylinder receptacle 12, in which, in this exemplary embodiment shown, an offset plate cylinder 2 is received. By sliding at least the plate cylinder receptacle 12 relative to the impression cylinder 4, the center-to-center distance a between the plate cylinder 2 and the impression cylinder 4 can be varied. The offset plate cylinder 2 is drivable by means of the earlier-mentioned drive (not shown in this figure) in a rotational direction R. The impression cylinder 4 is provided fixedly in the printing module 1, at least immovably in the horizontal direction Dh, Dt. The impression cylinder 4 is positioned with respect to the offset plate cylinder 2, such that the respective central axes h, H of the two cylinders 2, 4, at a mutual distance a, extend in a same direction. The two central axes h, H are situated at approximately the same distance from the guide 31 and therefore extend in a plane extending substantially parallel to the horizontal direction Dh, Dt. The offset ink system 5 comprises a moisturizing system 13 which has at least one moisturizing cylinder 15 for providing a water film on at least a part of the outer surface 2a of the offset plate cylinder 2. Further, the offset ink system 5 comprises an ink mechanism 14 provided with at least one ink application cylinder 16 for applying ink to the outer surface 2a of the offset cylinder 2, at least onto those locations of the surface 2a where no water has been applied. The ink application cylinder 16 is positioned lower than the moisturizing cylinder 15, viewed in a vertical direction. So the ink application cylinder 16 is situated nearer the guide 31 than the moisturizing cylinder 15. Upstream of the ink application cylinder 16 there is positioned at least one ink transfer cylinder 17 by which the ink to be applied is transferred onto the ink application cylinder 16. In this example of the printing module 1 shown, the offset plate cylinder 2 has a relatively large diameter. The offset plate cylinder 2 is therefore arranged for printing images of a relatively large pattern length.

In FIG. 3b the same printing module 1 as shown in FIG. 3a is represented, albeit that the offset plate cylinder 2 is suitable for printing images of a smaller pattern length than the offset plate cylinder 2 in FIG. 3a. To exchange the offset plate cylinder 2 for an offset plate cylinder 2 of a smaller diameter, the ink system 5 can be displaced in horizontal direction Dh away from the plate cylinder 2. As a result, a space is formed between the ink system 5 and the plate cylinder 2, so that the operator of the printing apparatus can easily access the plate cylinder 2 to take it out of the plate cylinder receptacle 12 and to replace it with an offset plate cylinder 2 of a smaller diameter. After placing the offset plate cylinder 2, first the plate cylinder receptacle 12 is displaced in the same horizontal direction Dt in the direction of the impression cylinder 4 to position the two cylinders 2, 4 against each other with the proper pressure. Next, the ink system 5 is moved in the same direction Dt, so that both the moisturizing cylinder 15 and the ink application cylinder 16 are positioned against the outer surface 2a of the offset plate cylinder 2 with the proper pressure. In this way, with the above-described construction of the printing module 1, the printing module 1 can be simply adapted to the offset plate cylinders 2 of different diameters for the purpose of printing images of different pattern lengths.

The above-described printing module 1 arranged for offset printing technology works as follows (see FIGS. 2a-2c, 3a and 3b). The offset plate cylinder 2 is provided with an offset plate 2b in which the desired image 10 is provided. Such an offset plate 2b can for instance comprise a thin aluminum or plastic plate which has been provided with the image 10 by a photochemical process. The offset plate cylinder 2 is placed in the printing module 1. The impression cylinder 4 is brought against the offset plate cylinder 2, or vice versa, with the aid of means which are provided in the printing module 1 for varying in a center-to-center distance a between the offset plate cylinder 2 and the impression cylinder 4, in this case the guide 31 and the plate cylinder receptacle 12 cooperating therewith. Since the impression cylinder 4 is not adapted for driven rotation, it moves along with the displacement of the substrate S. Accordingly, the size of the diameter of the impression cylinder 4 is less of importance in the module 1 according to the invention than in the known module, where the diameter is of relevance in order for the substrate web speed to correspond to the circumferential speed of the blanket cylinder. As a consequence, the impression cylinder 4 needs to be exchanged less, if at all, upon a change of the image or pattern length to be printed. The impression cylinder 4 may be constructed as a core 9a with an impression cylinder sleeve 9 provided around it. The impression cylinder 4, like the impression cylinder sleeve 9, may be removably provided in the printing module 1, for instance to allow it to be replaced.

The offset plate cylinder 2 is rotatably driven by a drive 6 (see FIGS. 2a-2c), which makes it possible for the offset plate cylinder 2 to be moisturized and thereupon to be provided with ink using the ink system 5. The ink system 5 is situated against the offset plate cylinder 2 for transferring ink onto the image 10. The image 10 is thereupon rotated along the substrate S, the paper web, so that the ink is imparted to the substrate S and forms an image 11 on the substrate S. Preferably, the impression cylinder 4, at least on an outer side 4a thereof, is provided with at least a layer of flexible material, for instance rubber. Such a layer of flexible material can take up fluctuations in the substrate thickness, so that the quality of the printed image is high. Naturally, it is possible, in another embodiment of the invention, that the impression cylinder 4 as a whole is of a flexible material, or also comprises layers of another material. The printing module 1 according to the invention has a relatively simple construction. As a result, the printing module 1 allows of easy operation and flexible deployment. By replacing the offset plate cylinder 2, a different printing technology on the offset printing module 1 can be provided for in a simple manner.

In FIGS. 4a-4c, it can be seen, for instance, that the offset printing technology is replaced with, for instance, gravure (see FIG. 4b) or flexographic printing technology (see FIG. 4c).

The plate cylinder 2, 2′, 2″, as can be seen in FIG. 4a, can comprise a core 7 around which is provided a cylinder sleeve 8, 8′, 8″. The offset plate cylinder sleeve 8 can be removed from the core 7, after which, for instance, an engraved cylinder sleeve 8′ is slid around the core 7 (see FIG. 4b). Further, the ink system 5, 5′, 5″ can be adapted to the gravure printing technology, for instance by taking the offset ink system 5 out of the printing module 1 and placing a gravure ink system 5′ therein. Such an engraved cylinder 2′ comprises an image 10′ formed from engraved or etched wells provided in an outer cylinder surface 2a′ of for instance a copper or chromium cylinder. The wells in use are filled with ink, whereupon an excess of ink is wiped off the surface 2a′ with a doctor blade before the image 10′ is transferred onto the substrate S.

FIG. 4c shows the printing module 1 according to the invention provided with a flexographic printing technology. For this purpose, the offset plate cylinder sleeve 8 of the offset plate cylinder 2 is replaced with a flexographic plate cylinder sleeve 8″. This sleeve 8″ is provided with a relief pattern 10″. The ink system 5″, for the purpose of the flexographic printing technology, is arranged for applying ink onto the relief pattern 10″. For this, the ink system 5″ may be provided with a rubber roller which applies ink to an anilox roller 19 (see FIGS. 5a and 5b). The anilox roller 19 transfers the ink onto the relief pattern 10″. The driven flexographic plate cylinder 2″ then rotates the relief pattern 10″ along the substrate S whereby the ink is transferred onto the substrate S. The flexographic plate cylinder 2″ has a flexible surface. When the impression cylinder 4, or at least an outer surface layer, is also of a flexible material, this provides the advantage that the relief constituting the image 10″ on the flexographic plate cylinder 2″ is not deformed. This is favorable to the quality of the eventual printed image 11 on the substrate S.

FIGS. 5a and 5b show an example of a printing module 1 arranged for flexographic printing technology, as described above in relation to FIG. 4c. The printing module 1 comprises substantially the same parts as those described with reference to FIGS. 3a and 3b. Therefore, with reference to FIGS. 5a and 5b, only the elements that differ from the elements in FIGS. 3a and 3b will be described in detail here. In this exemplary embodiment of the printing module 1 according to the invention, the ink system 5 is not removably provided in the printing module 1. The offset ink system 5 is arranged to be used for the offset printing technology as described in relation to FIGS. 3a and 3b. However, the ink system 5 comprises, in addition to the moisturizing system 13 and the ink mechanism 14 which is provided with the at least one ink application cylinder 16 and the at least one ink transfer cylinder 17, a holder 18. The holder 18 is provided with a receiving provision 18a in which an anilox roller 19 can be received. As can be seen in FIGS. 3a and 3b, during offset printing, no anilox roller 19 is provided in the holder 18. In this way, it is possible that the ink application cylinder 16 is situated between outer holder parts and can be in contact with the outer surface 2a of the offset plate cylinder 2.

The ink system 5, however, is so arranged that the ink application cylinder 16 is movable relative to the ink transfer cylinder 17. In this example of the printing module 1, the ink application cylinder 16 is rotatable about the central axis 17a of the ink transfer cylinder in a direction Ri away from the plate cylinder 2.

To further arrange the printing module 1 to render it suitable for flexographic printing, the offset plate cylinder 2 is replaced with a flexographic plate cylinder 2″ as described with reference to FIG. 4c. In addition, the ink application cylinder 16 is moved away from the plate cylinder 2, so that between the plate cylinder 2, the ink mechanism 14 and the holder 18 a space is formed. As a result, the receiving provision 18a of the holder 18 comes to be exposed, so that an anilox roller 19 can be received therein. Further, in the holder 18, under the anilox roller 19, a flexographic ink provision 20 is placed, which is arranged to apply ink via the anilox roller 19 onto the flexographic plate cylinder 2″. Both the plate cylinder receptacle 12 having therein the flexographic plate cylinder 2″ and the ink system 5 are thereupon moved over the guide 31 in the horizontal direction Dt in the direction of the impression cylinder 4. As a result, the flexographic plate cylinder 2″ comes to lie with the proper pressure against the impression cylinder 4, at least the substrate S situated between the two cylinders 2″, 4, and the anilox roller 19 is positioned with the proper pressure against the outer surface 2a″ of the flexographic plate cylinder 2″. The moisturizing cylinder 15 and the ink application cylinder 16 are situated at a distance from the flexographic plate cylinder 2″. The flexographic plate cylinder 2a″ as shown in FIG. 5a has a relatively large diameter for printing an image of a relatively large pattern length onto the substrate S. In FIG. 5b, the printing module 1 is provided with a flexographic plate cylinder 2a″ of a relatively small diameter for printing an image of a relatively small pattern length onto the substrate S. As can be clearly seen in FIGS. 5a and 5b, the rotational direction R, r of both the flexographic plate cylinder 2″ and the impression cylinder 4 in the printing module 1 adapted for flexographic printing remains equal to the rotational direction R, r of the offset plate cylinder 2 and the impression cylinder 4 of the printing module 1 when arranged for offset printing. As a consequence, the web direction Rs of the substrate S in the printing module 1 arranged for flexographic printing technology likewise remains equal to the web direction Rs of the substrate in the printing module 1 arranged for offset printing, as represented in FIGS. 3a and 3b. The substrate S can even remain present in the printing module 1 during the change of printing technology. Further, in this way, the printing module 1 can comprise a simple substrate feed. So the printing module 1 can be easily changed from the offset printing technology to flexographic printing technology.

In FIGS. 6a and 6b, a printing module 1 arranged for screen printing technology is shown. The printing module 1 comprises substantially the same parts as those described with reference to FIGS. 3a and 3b. Therefore, referring to FIGS. 6a and 6b only the elements that differ from the elements in FIGS. 3a and 3b will be described in detail here. The printing module 1 arranged for screen printing comprises the same impression cylinder 4, preferably with an outer surface of rubber, as the printing module 1 arranged for offset printing or for flexographic printing as described earlier. Further, the printing module 1 comprises both the plate cylinder receptacle 12 and the offset ink system 5. The offset ink system 5 is not needed when the printing module 1 is arranged for the screen printing technology. Therefore the offset ink system 5 is displaced, during the change of printing technology, away from the plate cylinder receptacle 12 over the guide 31 in the horizontal direction Dh. In this position the moisturizing cylinder 15 and the ink application cylinder 16 are at a distance from the plate cylinder receptacle 12. The offset plate cylinder 2 has been removed from the plate cylinder receptacle 12 and replaced with a core 7′. When the offset plate cylinder 2 comprises a core 7 and an offset plate cylinder sleeve 8 provided around it, only the sleeve 8 needs to be taken from the core 7. The printing module 1 further comprises a bearing 20 which is positioned such that a screen cylinder 2′″ can be received and enclosed between the core 7′ and the bearing 20, as shown in FIGS. 6a and 6b. The screen cylinder 2″′ comprises an outer side 2a″′ which is provided with a screen pattern (not shown) comprising an amount of holes, through which ink can be delivered to the substrate S using the doctor blade device (not shown). The doctor blade device is provided inside the rotary screen cylinder 2″′ for wiping off ink provided in the cylinder inner space P during rotary screen printing of the image onto the substrate S. The rotary screen cylinder 2″′ is adapted at both ends, that is, both on the operating side of the printing module 1 and on the driving side of the printing module 1, for cooperating with the bearing 20. In this exemplary embodiment of the printing module 1, the bearing 20 is provided on a first side of the screen cylinder 2 remote from the ink system 5 viewed in the horizontal direction Dt. The bearing 20 is an outer circumferential bearing and cooperates with an outer circumferential edge 26 of the rotary screen cylinder 2′″. The bearing 20 is provided with a number of bearing wheels 22, 23 which are provided on a bearing frame 21. The bearing frame 21 may be movably or fixedly provided in the printing module 1. The bearing 20 comprises two pairs of bearing wheels 22, 23 which are provided on opposite sides of a plane V, which extends through the respective central axes h, H_{R}, H of the core 7′ and the respective cylinders 2′″, 4. The bearing wheels 22 of the first pair of bearing wheels are positioned at a mutual distance, such that upon use of a screen cylinder 2′″ of a relatively large diameter (as shown in FIG. 6a) an outer surface 2a′″ of the screen cylinder 2′″ cooperates with respective circumferential surfaces 22a of the respective bearing wheels 22. In this case, the circumferential surfaces 23a of the bearing wheels 23 are not contacted by the outer circumferential edge 26 of the screen cylinder 2″′. The screen cylinder 2″′ on the side remote from the plate cylinder receptacle 12 is therefore received by the bearing wheels 22. On the side of the plate cylinder receptacle 12, the screen cylinder 2′″ is clamped by an outer surface 24a of the core 7′. The bearing 20 is positioned with respect to the impression cylinder 4, such that the outer surface 2a″′ of the screen cylinder 2″′ is held with a desired pressure against the outer surface 4a of the impression cylinder 4, at least against the substrate S passing between the impression cylinder 4 and the screen cylinder 2′″. In a further elaboration of the invention, the bearing 20 can be displaced relative to the impression cylinder 4 in the horizontal direction Dh, Dt. In another elaboration of the invention, the bearing 20 may be fixedly provided in the frame 30 of the printing module 1, and the impression cylinder 4 may be provided movably, for instance in horizontal direction Dh, Dt relative to the bearing 20. The doctor blade device (not shown) is fixedly provided in the printing module 1, so that the rotary screen cylinder 2″′ in use rotates around the doctor blade for applying ink to the outer circumferential surface 2a″′ of the rotary screen cylinder 2′″. As a result, the doctor blade, which is for instance of a flexible plastic, is held against the inner circumferential surface of the screen cylinder 2″′ in the desired manner. The screen cylinder 2″′ is driven via the core 7′ which in turn is driven by a drive (not shown) provided on the driving side of the printing module 1. The core 7′ comprises two transmission elements, in this example two gear wheels 25 which are provided adjacent ends of the core 7′. The gear wheels 25 engage transmission elements 27 which are situated opposite the gear wheels 25 adjacent ends of the screen cylinder 2″′. As the core 7′ is driven, the screen cylinder 2″′ is driven, which in turn drives the impression cylinder 4. In FIG. 6b, finally, the printing module 1 according to the invention is shown which is arranged for the screen printing technology, where the diameter of the screen cylinder 2′″ is relatively small for printing images of a relatively small pattern length. In the use of a screen cylinder 2″′ of a relatively small diameter, that is, in any case smaller than the diameter of the screen cylinder 2″′ as shown in FIG. 6a, the second pair of bearing wheels 23 is used for clamping the screen cylinder 2′″. The circumferential surfaces 23a of the bearing wheels 23 cooperate with the outer circumferential edge 26 of the rotary screen cylinder 2′″. The bearing wheels 23 are positioned at a distance from the plane V and positioned with respect to the first pair of bearing wheels 22, such that the outer circumferential edge 26 of the screen cylinder 2″′ is not engaged by the first pair of bearing wheels 22. By providing the bearing 20 with thus positioned pairs of bearing wheels 22, 23, the bearing 20 can be used both for screen cylinders 2′″ of a relatively large diameter and for screen cylinders 2′″ of a relatively small diameter, without the bearing 20 needing to be adapted when changing the screen cylinders 2′″. Also when the printing module 1 is arranged for screen printing technology, the rotational direction R of the screen cylinder 2″′ is equal to the rotational direction R of the offset plate cylinder 2 when the printing module 1 is arranged for offset printing technology. Therefore, also the web direction Rs of the substrate S passing between the screen cylinder 2″′ and the impression cylinder 4 is equal to the web direction Rs of the substrate S in the printing module 1 arranged for offset printing technology. Therefore the printing module 1 can be simply converted by means of just a few operations from offset printing technology to rotary screen printing technology and vice versa. Similarly, the printing module 1 can be simply converted from flexographic printing technology to rotary screen printing technology and vice versa. Neither the impression cylinder 4 nor the substrate web S being pulled through the printing apparatus need to be displaced, or removed, before changing the printing technology of the printing module 1.

It will be clear that not only the above exemplary embodiment falls within the scope of the invention. Also other variants are understood to fall within the scope of the invention as defined in the appended claims. For instance, both the plate cylinder and the impression cylinder may be designed in different ways. For instance, the impression cylinder may possess an outer circumferential surface other than a flexible one, for instance a non-flexible, hard circumferential surface as from steel. The plate cylinder may then have a circumferential surface arranged to cooperate with such an impression cylinder. Further, these cylinders may be bearing-mounted, be driven and be set in different ways. For instance, the distance between the two cylinders may be set in different ways. Also, the changing of the cylinders or of the cylinder sleeves may be effected in different ways, inter alia depending on the construction of the printing module and/or on the construction of the offset printing apparatus in which the printing module is provided. Further, the offset ink system may have different configurations in which different moisturizing systems and/or different ink mechanisms may be present. The moisturizing systems and the ink mechanisms may comprise different cylinders and different numbers of cylinders. Also, the different cylinders may be positioned with respect to each other in different ways. The printing apparatus according to the invention may for instance be a label printing apparatus and further be arranged for at least one of the following techniques: perforating the substrate, removing waste material of the substrate, at least partly punching the substrate, foil laminating, printing an inside of the substrate, metal effect printing of the substrate, and the like.

1-16. (canceled)

17. A printing module for use in an offset printing apparatus, wherein the printing module is provided with an offset plate cylinder provided with an image to he transferred onto a substrate, wherein the printing module is further provided with an ink system for applying ink onto the offset plate cylinder, at least onto the image provided thereon, and with an impression cylinder, wherein the impression cylinder is arranged, at least in use, to hold the substrate passing between the cylinders against the offset plate cylinder to transfer the image from the offset plate cylinder directly onto the substrate, wherein the printing module is arranged to enable changing from offset printing technology to at least one other printing technology, not being offset printing, characterized in that the offset plate cylinder is rotatably drivable and the impression cylinder is arranged for non-driven rotation such that it moves along with the displacement of the substrate and wherein at least the plate cylinder and the impression cylinder are positioned with respect to each other in the printing module, such that both a rotational direction of a respective plate cylinder and a web direction (Rs) of the substrate (S) in the respective other printing technology comprise a same direction as in the offset printing technology.

18. A printing module according to claim 17, wherein at least an outer surface of the impression cylinder is of a flexible material, for instance of a rubber.

19. A printing module according to claim 17, wherein the offset plate cylinder is removably provided in the printing module in order to exchange the offset plate cylinder for another plate cylinder to enable variation in pattern length and/or printing technology.

20. A printing module according to claim 17, wherein the offset plate cylinder comprises a core which is provided with an offset plate cylinder sleeve detachable from the core, thus allowing variation in pattern length and/or printing technology.

21. A printing module according to claim 17, wherein the printing module is provided with means for varying in a center-to-center distance between the plate cylinder and the impression cylinder.

22. A printing module according to claim 17, wherein the offset ink system is provided in the printing module movably with respect to the plate cylinder.

23. A printing module according to claim 17, wherein the printing module comprises a moisturizing system for moisturizing the offset plate cylinder, wherein a moisturizing cylinder of the moisturizing system is placed higher in a vertical direction than an ink application cylinder of the offset ink system.

24. A printing module according to claim 17, wherein the ink application cylinder of the offset ink system is provided in the offset ink system movably with respect to a cylinder provided upstream thereof.

25. A printing module according to claim 24, wherein the ink application cylinder is rotatable around an ink transfer cylinder in a direction away from the plate cylinder.

26. A printing module according to claim 19, wherein the printing module is arranged to change to flexographic printing technology by replacing the offset plate cylinder with a flexographic plate cylinder.

27. A printing module according to claim 19, wherein the printing module is arranged to change to rotary screen printing technology by replacing the offset plate cylinder with a rotary screen cylinder.

28. A printing module according to claim 27, wherein the printing module comprises a screen bearing which is arranged to receive the rotary screen cylinder, wherein the screen cylinder in use is positioned between a core provided in a plate cylinder receptacle and the screen bearing.

29. A printing module according claim 19, wherein the printing module is arranged to change to gravure printing technology by replacing the offset plate cylinder with an engraved plate cylinder.

30. A printing module according to claim 17, wherein the impression cylinder comprises a core which is provided with an impression cylinder sleeve detachable from the core.

31. A printing module according to claim 17, wherein the impression cylinder is removably provided in the printing module.

32. An offset printing apparatus provided with a printing module according to claim 17.

33. A printing module according to claim 18, wherein the offset plate cylinder is removably provided in the printing module in order to exchange the offset plate cylinder for another plate cylinder to enable variation in pattern length and/or printing technology.

34. A printing module according to claim 18, wherein the offset plate cylinder comprises a core which is provided with an offset plate cylinder sleeve detachable from the core, thus allowing variation in pattern length and/or printing technology.

35-36. (canceled)

37. A printing module according to claim 20, wherein the printing module is arranged to change to flexographic printing technology by replacing the offset plate cylinder sleeve by a flexographic plate cylinder sleeve.

38. A printing module according claim 20, wherein the printing module is arranged to change to gravure printing technology by replacing the offset plate cylinder sleeve with an engraved plate cylinder sleeve.
